(19) United States
(12) Patent Application Publication
(10) Pub. No.: US 2025/0173637 A1
(43) Pub. Date: May 29, 2025

(54) INFORMATION PROCESSING APPARATUS, INFORMATION PROCESSING METHOD, AND COMPUTER PROGRAM PRODUCT

(71) Applicants: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(72) Inventors: Yacheng WANG, Shinjuku Tokyo (JP); Takufumi YOSHIDA, Funabashi Chiba (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(21) Appl. No.: 18/760,112

(22) Filed: Jul. 1, 2024

(30) Foreign Application Priority Data
Nov. 28, 2023 (JP) 2023-200902

(51) Int. Cl. G06Q 10/0631; G06Q 10/08

(52) U.S. Cl. CPC G06Q 10/06311; G06Q 10/06316; G06Q 10/08

(57) ABSTRACT

An information processing apparatus includes a processing unit implemented as one or more hardware processors. The processing unit determines an order on the basis of a loading/unloading time for each of a plurality of vehicles, the order being an order of going around a plurality of buildings each including one or more loading/unloading working areas, and the loading/unloading time being calculated on the basis of an allocated stock among stocks of goods stored in the plurality of buildings. The processing unit assigns one or more vehicles selected from the plurality of vehicles on the basis of the order to each of one or more target periods during which loading/unloading work is performed in each of the one or more loading/unloading working areas.

### CROSS-REFERENCE TO RELATED APPLICATIONS

This application is based upon and claims the benefit of priority from Japanese Patent Application No. 2023-200902, filed on Nov. 28, 2023; the entire contents of which are incorporated herein by reference.

### FIELD

Embodiments described herein relate to an information processing apparatus, an information processing method, and a computer program product.

### BACKGROUND

While logistics volume increases year by year, shortage of drivers of vehicles used for logistics is becoming a social problem. For example, it is required to reduce a loading waiting time in a warehouse and improve a work environment for drivers. As one of solutions, there has been proposed a technique of reducing the loading waiting time by improving efficiency of assignment using a berth reservation system. A berth is an area (loading/unloading working area) in which loading/unloading work is performed with a vehicle.

In recent years, for example, as warehouses are consolidated and become massive and joint delivery is utilized, there are more opportunities for one vehicle to go around a plurality of buildings in a warehouse to execute loading/unloading work. Each of the plurality of buildings includes one or more berths. The conventional berth reservation system does not consider that a vehicle goes around a plurality of buildings, and therefore there has been a case where a vehicle is not appropriately assigned to a berth.

### BRIEF DESCRIPTION OF THE DRAWINGS

FIG. 1 is a schematic diagram of an information processing system including an information processing apparatus according to a first embodiment;

FIG. 2 is a block diagram of the information processing apparatus according to the first embodiment;

FIG. 3 is a diagram illustrating an example of a data structure and data of a bar master;

FIG. 4 is a diagram illustrating an example of a data structure and data of registered vehicle information;

FIG. 5 is a diagram illustrating an example of a data structure and data of assignment zone information;

FIG. 6 is a flowchart of berth assignment processing according to the first embodiment;

FIG. 7 is a diagram illustrating an example of a data structure and data of loaded product information;

FIG. 8 is a diagram illustrating an example of a data structure and data of warehouse capacity information;

FIG. 9 is a diagram illustrating an example of a data structure and data of an allocation priority master;

FIG. 10 is a diagram illustrating an example of a data structure and data of allocation information;

FIG. 11 is a diagram illustrating an example of a data structure and data of a work efficiency master;

FIG. 12 is a diagram illustrating an example of a data structure and data of loading/unloading time information;

FIG. 13 is a diagram illustrating an example of a data structure and data of a movement time master;

FIG. 14 is a diagram illustrating an example of a data structure and data of vehicle state information;

FIG. 15 is a diagram illustrating an example of a data structure and data of an incidental work master;

FIG. 16 is a diagram illustrating an example of a data structure and data of go-around order information;

FIG. 17 is a diagram illustrating an example of a data structure and data of a vehicle size condition;

FIG. 18 is a diagram illustrating an example of a data structure and data of a warehousing in/out condition;

FIG. 19 is a diagram illustrating an example of a data structure and data of a route condition;

FIG. 20 is a diagram illustrating an example of a data structure and data of assignment vehicle candidate evaluation information;

FIG. 21 is a diagram illustrating an example of a data structure and data of assignment vehicle information;

FIG. 22 is a schematic diagram of an information processing system including an information processing apparatus according to a second embodiment;

FIG. 23 is a block diagram of the information processing apparatus according to the second embodiment;

FIG. 24 is a diagram illustrating an example of a data structure and data of a berth use time master;

FIG. 25 is a diagram illustrating an example of a data structure and data of an unavailable berth condition;

FIG. 26 is a flowchart of berth assignment processing according to the second embodiment;

FIG. 27 is a diagram illustrating an example of assignment vehicle information according to the second embodiment; and

FIG. 28 is a hardware configuration diagram of the apparatus according to the first or second embodiment.

### DETAILED DESCRIPTION

According to an embodiment, an information processing apparatus includes one or more hardware processors. The processors are configured to determine an order on a basis of a loading/unloading time for each of a plurality of vehicles, where the order is an order of going around a plurality of buildings each of which includes one or more loading/unloading working areas, and the loading/unloading time is calculated on a basis of an allocated stock among stocks of goods stored in the plurality of buildings. Furthermore, the processors are configured to assign one or more vehicles selected from the plurality of vehicles on a basis of the order to each of one or more target periods during which loading/unloading work is performed in each of the one or more loading/unloading working areas. Hereinafter, preferred embodiments of an information processing apparatus according to the present disclosure will be described in detail with reference to the accompanying drawings.

In the following embodiments, to support a case where loading/unloading work is performed by going around a plurality of buildings (an example of a plurality of buildings) in a warehouse, a go-around order of the plurality of buildings is derived so as to reduce a loading waiting time, then extraction of candidates of a vehicle to be assigned and calculation of an evaluation point are executed on the basis of the go-around order, and assignment of the vehicle to a berth is determined. By adjusting the go-around order of the plurality of buildings, it is possible to further reduce the loading waiting time.

An information processing apparatus according to the embodiments has, for example, following functions.
(F1) A stock allocation function of allocating goods (such as products) transported by the vehicle to the stock of each building
(F2) A loading/unloading time calculation function of calculating a loading/unloading time on the basis of an allocated stock amount and work efficiency
(F3) A go-around order determination function of determining a go-around order of a plurality of buildings on the basis of information including the loading/unloading time
(F4) An assignment vehicle candidate extraction function of extracting assignable vehicle candidates (assignment vehicle candidates) on the basis of a go-around order, a docking condition, and the like
(F5) An evaluation value calculation function of calculating evaluation values of the assignment vehicle candidates
(F6) An assignment vehicle selection function of selecting a vehicle to be assigned from the assignment vehicle candidates on the basis of the evaluation value

The information processing apparatus according to the embodiments may further include at least part of the following functions.
Buildings to go around (hereinafter, go-around buildings) and a loading/unloading time for each go-around building are calculated according to stock allocation.
The loading/unloading time is calculated in consideration of work efficiency in accordance with a packing mode (such as a pallet, a case, or a piece).
In a case of distributed stocks, allocation is performed according to a building allocation priority (the priority of allocation).
The go-around order is determined so as to smooth the degrees of congestion of each building.
In the case of the distributed stocks, the building allocation priority is adjusted to further smooth the degrees of congestion.
A berth is allocated in consideration of the docking condition (such as a vehicle size condition, a warehousing in/out condition, or a route condition).
An evaluation value is calculated according to a margin time left until outgoing.

Note that goods stored in a warehouse and transported by a vehicle may be anything, and are, for example, handled as products. Hereinafter, a case where the goods are products will be described as an example. Furthermore, the distributed stocks means that the goods (products) of the same type are stored in a plurality of buildings in a distributed manner.

Examples of use cases of vehicle assignment include following examples.
(U1) Real-time assignment of determining an assignment vehicle to a berth that needs to be assigned
(U2) A berth assignment plan of all vehicles in a certain period is created

Hereinafter, a first embodiment that is mainly applicable to the use case U1 and a second embodiment that is mainly applicable to the use case U2 will be described separately.

### First Embodiment

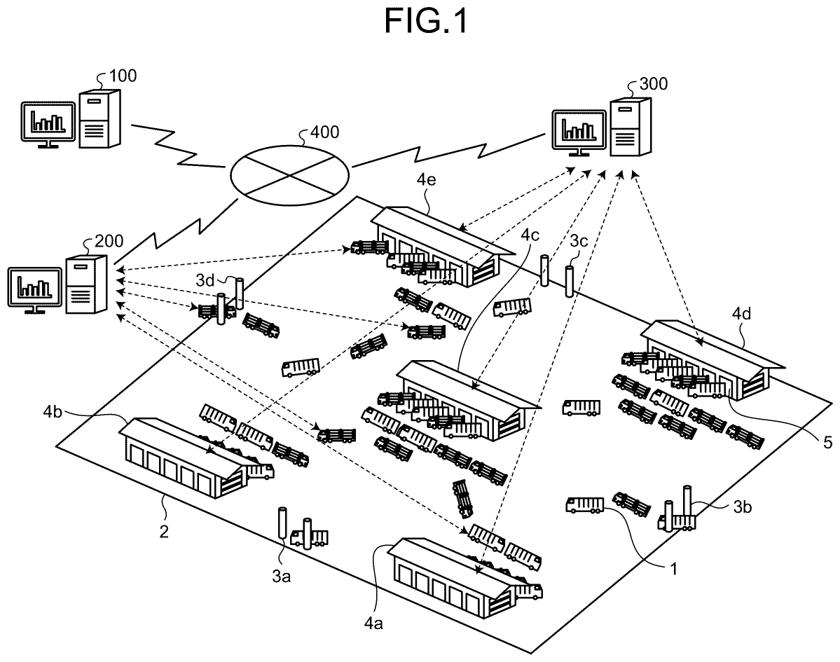

FIG. 1 is a schematic diagram of an information processing system including an information processing apparatus 100 according to the first embodiment. As illustrated in FIG. 1, the information processing system includes a plurality of vehicles 1, a warehouse 2, the information processing apparatus 100, a vehicle management apparatus 200, a warehouse management apparatus 300, and a network 400. The warehouse 2 includes a plurality of entrance/exit gates 3a, 3b, 3c, and 3d and a plurality of buildings 4a, 4b, 4c, 4d, and 4e. Each of the plurality of buildings 4a, 4b, 4c, 4d, and 4e include a plurality of berths 5.

The entrance/exit gates 3a, 3b, 3c, and 3d are gates for the vehicle 1 to enter and exit the warehouse 2 (an area in which a plurality of buildings are located). The entrance/exit gates 3a, 3b, 3c, and 3d are simply referred to the entrance/exit gates 3 in a case where the entrance/exit gates 3a, 3b, 3c, and 3d do not need to be distinguished. The number of the entrance/exit gates 3 is not limited to four, and may be one to three or five or more.

Each of the plurality of buildings 4a, 4b, 4c, 4d, and 4e is a building that can store goods. The buildings 4a, 4b, 4c, 4d, and 4e will be simply referred to as the building 4 in a case where the buildings 4a, 4b, 4c, 4d, and 4e do not need to be distinguished. The number of the buildings 4 is not limited to four, and may be two to three or five or more.

The berth 5 is a loading/unloading working area that is located in each of the plurality of buildings 4 and in which the vehicle 1 is docked to perform loading/unloading work.

The vehicle management apparatus 200 is an apparatus that transmits and receives information of the vehicle 1 and manages the vehicle 1. The warehouse management apparatus 300 is an apparatus that transmits and receives information (e.g., stock information) of the buildings 4 and manages the buildings 4. The information processing apparatus 100 corresponds to an apparatus (berth assignment apparatus) that assigns berths on the basis of the information from the vehicle management apparatus 200 and the warehouse management apparatus 300.

The network 400 is a network for each apparatus in the information processing system to perform data communication. The network 400 may be any form of a network, and is, for example, a Local Area Network (LAN) or the Internet.

In the present embodiment, the information processing apparatus 100 performs, for example, processing (berth assignment) of assigning loading/unloading work of the vehicle 1 to a future specific time zone of the certain berth 5, and displays a berth assignment result to a user or transmits the berth assignment result to a driver of the vehicle 1. For example, the information processing apparatus 100 can be utilized for a service of assigning the vehicle 1 in the warehouse to the berth 5 that is likely to be available in the near future and reserving the berth 5.

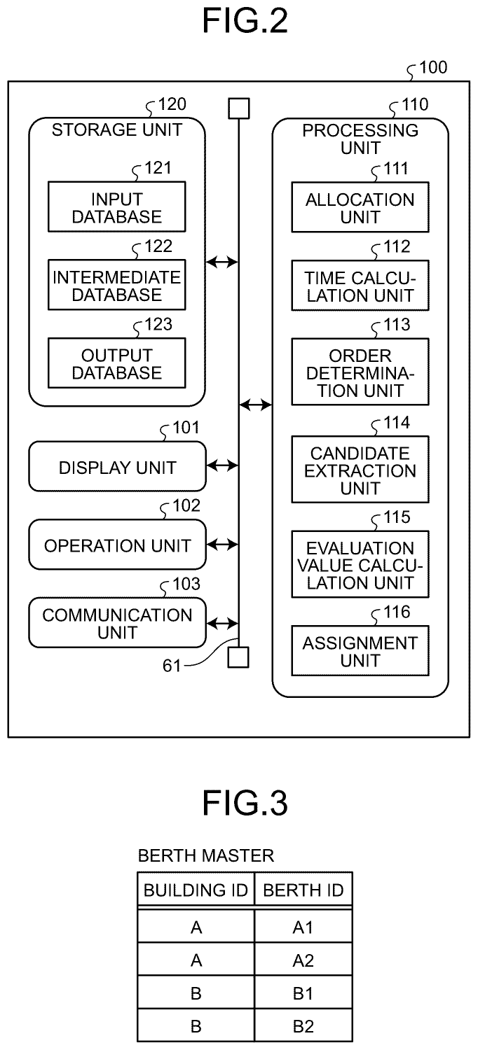

FIG. 2 is a block diagram illustrating an example of a configuration of the information processing apparatus 100 according to the first embodiment. As illustrated in FIG. 1, the information processing apparatus 100 includes a processing unit 110, a storage unit 120, a display unit 101, an operation unit 102, a communication unit 103, and a bus 61.

The storage unit 120 stores various types of data used for various types of processing by the information processing apparatus 100. The data stored in the storage unit 120 is mainly classified into input data, intermediate data, and output data. An input database 121, an intermediate database 122, and an output database 123 respectively correspond to databases that store input data, intermediate data, and output data.

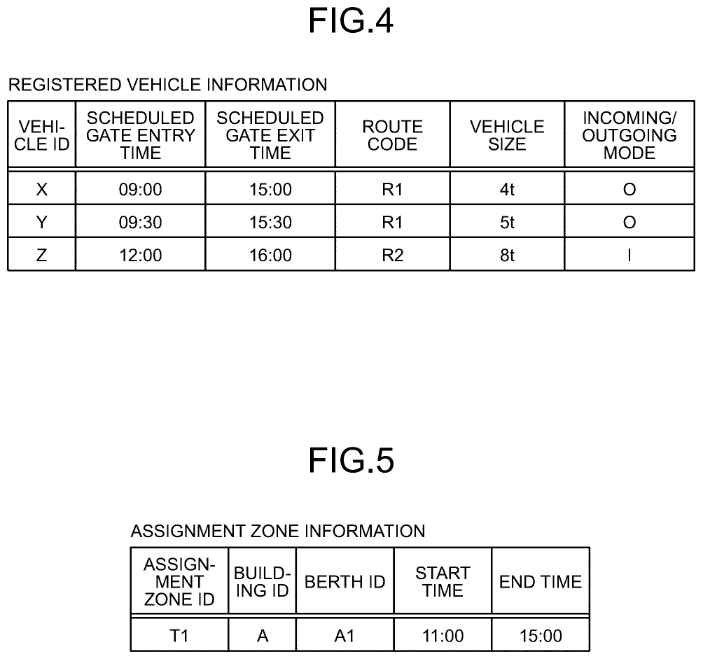

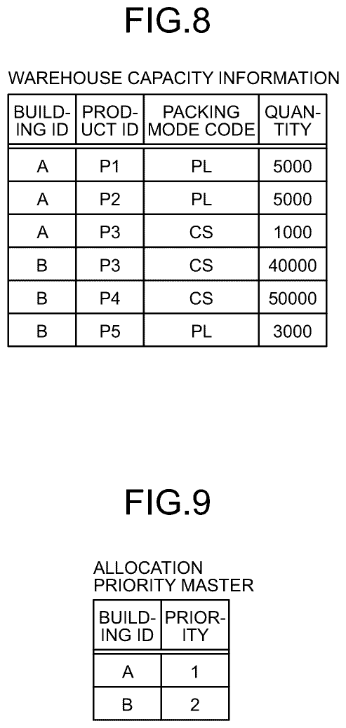

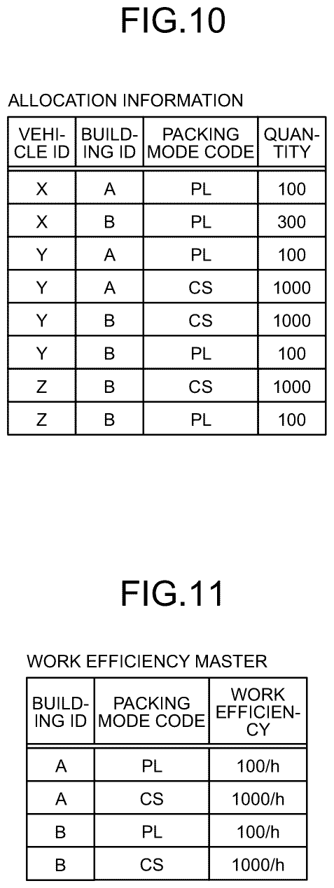

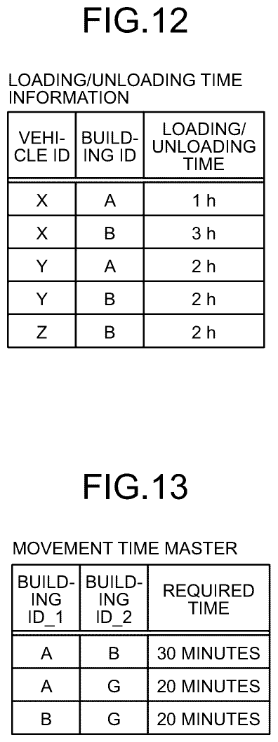

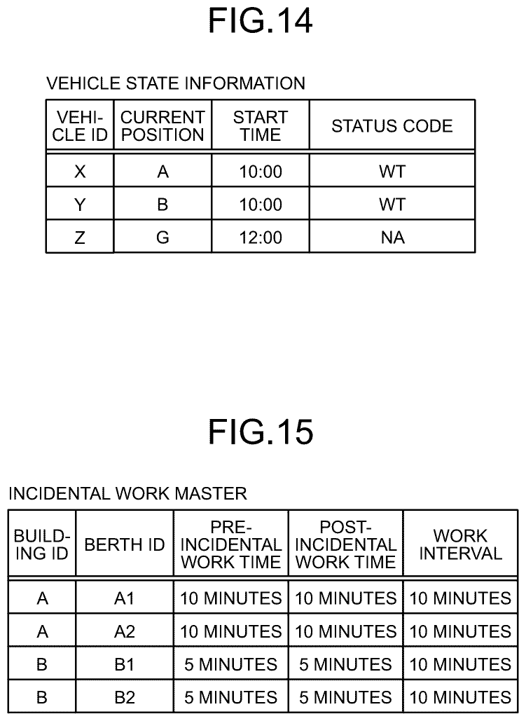

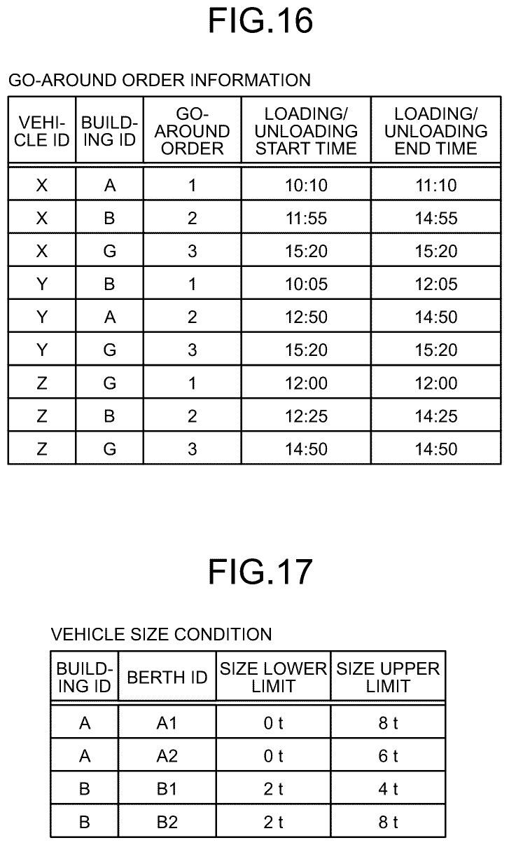

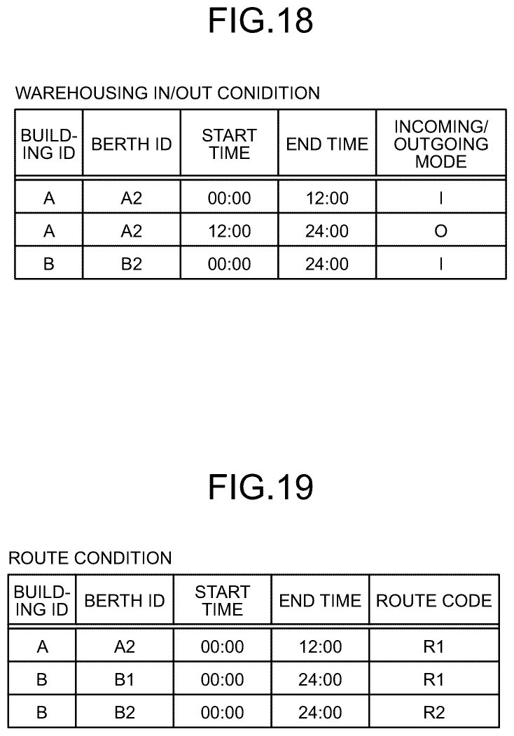

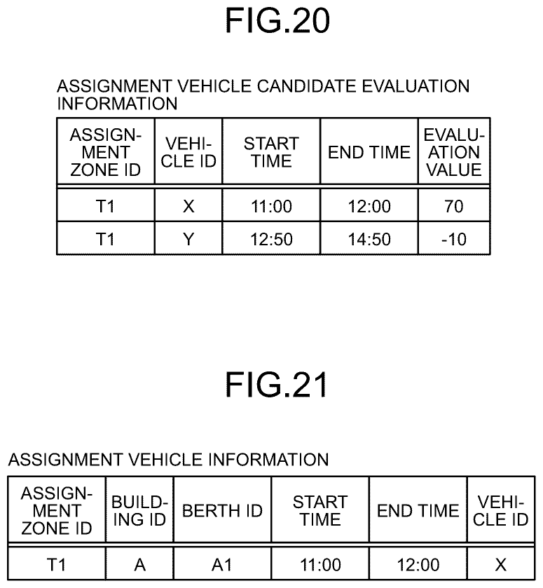

Although details of the input database 121, the intermediate database 122, and the output database 123 will be described later, each database is associated with, for example, the following data. Note that the data stored in the input database 121 may be acquired from the vehicle management apparatus 200 or the warehouse management apparatus 300.
Input database 121: bar master (FIG. 3), registered vehicle information (FIG. 4), assignment zone information (FIG. 5), loaded product information (FIG. 7), warehouse capacity information (FIG. 8), allocation priority master (FIG. 9), work efficiency master (FIG. 11), movement time master (FIG. 13), vehicle state information (FIG. 14), incidental work master (FIG. 15), vehicle size condition (FIG. 17), warehousing in/out condition (FIG. 18), and route condition (FIG. 19)
Intermediate database 122: allocation information (FIG. 10), loading/unloading time information (FIG. 12), go-around order information (FIG. 16), and assignment vehicle candidate evaluation information (FIG. 20)
Output database 123: assignment vehicle information (FIG. 21)

Note that the storage unit 120 can be configured as any commonly used storage medium such as a flash memory, a memory card, a Random Access Memory (RAM), a Hard Disk Drive (HDD), and an optical disc.

Each database (the input database 121, the intermediate database 122, and the output database 123) may be stored in a physically different storage medium, or may be stored in a different storage area of a physically identical storage medium.

The display unit 101 is a display apparatus such as a display for displaying input data, intermediate data, and output data. The operation unit 102 is, for example, a component for the user to perform an operation such as data input according to data displayed on the display unit 101, and is implemented as, for example, a keyboard, a mouse, and the like. The display unit 101 and the operation unit 102 may be implemented as a touch panel or the like formed by integrating both of the display unit 101 and the operation unit 102.

The communication unit 103 is a communication interface (I/F) for communicating with the vehicle management apparatus 200, the warehouse management apparatus 300, and other systems (apparatuses) through a communication line such as the network 400.

The bus 61 is a connection line that connects respective units (the processing unit 110, the storage unit 120, the display unit 101, the operation unit 102, and the communication unit 103).

The processing unit 110 performs various types of processing using the data stored in the storage unit 120. For example, the processing unit 110 acquires the data from the input database 121, executes the berth assignment, and writes the berth assignment result in the output database 123 of the storage unit 120. The data obtained as an intermediate product of the berth assignment is stored in the intermediate database 122 of the storage unit 120, and is used at a time of subsequent processing of the processing unit 110.

The processing unit 110 includes an allocation unit 111, a time calculation unit 112, an order determination unit 113, a candidate extraction unit 114, an evaluation value calculation unit 115, and an assignment unit 116. Note that the allocation unit 111, the time calculation unit 112, the order determination unit 113, the candidate extraction unit 114, the evaluation value calculation unit 115, and the assignment unit 116 correspond to, for example, the above functions (F1) to (F6), respectively.

The allocation unit 111 allocates stocks of goods stored in the plurality of buildings 4 to each of the plurality of vehicles 1. In a case of the distributed stocks, the allocation unit 111 may determine the buildings 4 to which the stocks are allocated and the quantities of the stocks to be allocated to the buildings 4 on the basis of the priority (allocation priority) determined for each of the plurality of buildings 4.

The time calculation unit 112 calculates the loading/unloading time at each of the plurality of buildings 4 on the basis of the allocated stock and predetermined loading/unloading work efficiency (hereinafter, work efficiency). The work efficiency is determined for, for example, each building 4 and each packing mode in the building 4. That is, the time calculation unit 112 calculates the loading/unloading time on the basis of the allocated stock and the work efficiency associated with the packing mode.

The packing mode indicates a storage state (such as a packing type) of a product at a time of loading/unloading work. For example, the packing mode includes a pallet, a case, and a piece.

Note that a setting unit of the work efficiency is not limited to the above, and may be any unit. For example, the work efficiency may be determined per product, per product group, and per vehicle 1 (driver).

The order determination unit 113 determines for each of the plurality of vehicles 1 on the basis of the calculated loading/unloading time an order (go-around order) of going around the plurality of buildings 4 for the loading/unloading work of the stock allocated to the vehicle 1. Details of a go-around order determination method will be described later.

The candidate extraction unit 114 extracts one or more candidates (assignment vehicle candidates) of the vehicle 1 to be assigned to one or more assignment zones from the plurality of vehicles 1 on the basis of the determined go-around order.

The assignment zone indicates a period (target period) that is a target for performing loading/unloading work at the berth 5. The assignment zone is a calculational concept that indicates a certain time zone (a start time to an end time) at the berth 5 of the certain building 4. The information processing apparatus 100 assigns the vehicle 1 (loading/unloading work of the vehicle 1) to the assignment zone.

The candidate extraction unit 114 may extract candidates on the basis of the docking condition determined for each berth 5 and the go-around order. The docking condition includes, for example, at least one of the following conditions.
A size condition of the vehicle 1 (vehicle size condition)
A condition indicating which one of incoming and outgoing (storage and shipping) is executed (warehousing in/out condition)
A condition indicating the vehicle 1 for which loading/unloading work is permitted (route condition)

Note that the route is information that indicates a group of the vehicles 1. The route is, for example, a transportation company that owns the one or more vehicles 1, a transportation area (information that indicates a transportation destination), and the like. In a case where, for example, the transportation company is designated as the route condition, candidates are extracted from the vehicles 1 belonging to the designated transportation company. When the transportation area is designated as the route condition, candidates are extracted from the vehicles 1 for which the designated transportation area is a destination.

The evaluation value calculation unit 115 calculates an evaluation value for each of the one or more extracted candidates. The evaluation value is an index of evaluation for assignment to each assignment zone.

For example, the evaluation value calculation unit 115 calculates the evaluation value on the basis of at least one of a date and time (gate entry time) at which the vehicle 1 enters the warehouse 2 (one of the entrance/exit gates 3) and a date and time (gate exit time) at which the vehicle 1 exits the warehouse 2 (one of the entrance/exit gates 3). The evaluation value calculation unit 115 may calculate the evaluation value on the basis of a difference between the gate exit time, and a date and time (scheduled gate exit time) at which the vehicle 1 is scheduled to exit the warehouse 2 (one of the entrance and exit gates 3).

More specifically, the evaluation value calculation unit 115 calculates the evaluation value by, for example, at least one of the following methods (E1) to (E3).
(E1) The evaluation value calculation unit 115 calculates the evaluation value such that the evaluation value increases in an ascending order of the gate entry time.
(E2) The evaluation value calculation unit 115 calculates the evaluation value such that the value increases in an ascending order of the gate exit time.
(E3) The evaluation value calculation unit 115 calculates the evaluation value such that the value increases in a descending order of a gate exit delay time (corresponding to the margin time left until gate exit) that is a difference between the gate exit time and the scheduled gate exit time.

The assignment unit 116 selects one or more candidates as an assignment vehicle on the basis of the evaluation value from the one or more extracted candidates for each of the one or more assignment zones, and allocates the one or more selected vehicles 1 (assignment vehicles).

Each constituting element (unit) of the processing unit 110 is implemented as, for example, one or more hardware processors. For example, each unit may be implemented by causing a processor such as a Central Processing Unit (CPU) and a Graphics Processing Unit (GPU) to execute a program, that is, may be implemented by software. Each unit may be implemented as a processor such as a dedicated Integrated Circuit (IC), that is, hardware. Each unit may be implemented by using software and hardware in combination. In a case where a plurality of processors are used, each processor may implement one of the units or may implement two or more of the units.

Furthermore, the information processing apparatus 100 may be physically configured as one apparatus or may be physically configured as a plurality of apparatuses. For example, the information processing apparatus 100 may be constructed on a cloud environment. Furthermore, each unit in the information processing apparatus 100 may be provided in a plurality of apparatuses in a distributed manner.

Next, details of processing of each unit by the information processing apparatus 100 will be further described. First, the building 4, the berth 5, the vehicle 1, and the assignment zone will be described. Hereinafter, a case where the warehouse 2 is configured as follows will be described as an example.
The warehouse 2 includes two building A and building B.
The building A includes two berths A1 and A2.
The building B includes two berths B1 and B2.
Any one of three vehicles X, Y, and Z is assigned to any one of the above four berths.

Furthermore, a data structure and a value of each data described below are examples for describing the present embodiment, and are not limited thereto. A configuration may be configured where, for example, a registration date and time, a registered user name, and the like are added as elements of each data and can be managed as history data.

The information indicating the association between the buildings 4 and the berths 5 is stored in the bar master included in the input database 121. FIG. 3 is a diagram illustrating an example of a data structure and data of the bar master. As illustrated in FIG. 3, the bar master includes a building ID and a berth ID.

The building ID is identification information for identifying the building 4. The berth ID is identification information for identifying the berth 5. Hereinafter, the building 4 whose building ID is “a” may be referred to as a building a, and the berth 5 whose berth ID is “b” may be referred to as a berth b. In an example in FIG. 3, the two berths A1 and A2 whose berth IDs are “A1” and “A2”, respectively, are registered in association with the building A whose building ID is “A”. Furthermore, the two berths B1 and B2 whose berth IDs are “B1” and “B2”, respectively, are registered in association with the building B whose building ID is “B”.

The information of the vehicle 1 is stored in the registered vehicle information included in the input database 121. FIG. 4 is a diagram illustrating an example of a data structure and data of the registered vehicle information. As illustrated in FIG. 4, the registered vehicle information includes a vehicle ID, a scheduled gate entry time, a scheduled gate exit time, a route code, a vehicle size, and an incoming/outgoing mode.

The vehicle ID is identification information for identifying the vehicle 1. The route code is identification information for identifying a route (a group of the vehicles 1). The incoming/outgoing mode is information for identifying whether the corresponding vehicle 1 performs loading (outgoing) or unloading (incoming). In an example in FIG. 4, an incoming/outgoing mode “O” is registered for the vehicle 1 for outgoing, and an incoming/outgoing mode “I” is registered for the vehicle 1 for incoming. In the example in FIG. 4, the vehicle size is indicated by the weight (t: ton) of the vehicle 1, but may be indicated by another index.

Hereinafter, the vehicle 1 whose vehicle ID is “c” may be referred to as a vehicle c. In the example in FIG. 4, the vehicles X, Y, and Z are registered in the registered vehicle information, and the scheduled gate entry time, the scheduled gate exit time, the route code, the vehicle size, and the incoming/outgoing mode thereof are registered.

As described above, the assignment zone indicates a certain time zone (a start time to an end time) in the berth 5 that is an assignment target of the certain building 4. The vehicle 1 that can execute the loading/unloading work at the corresponding berth 5 within the range from the start time to the end time is assigned. The information of the assignment zone is stored in the assignment zone information included in the input database 121.

FIG. 5 is a diagram illustrating an example of a data structure and data of the assignment zone information. As illustrated in FIG. 5, the assignment zone information includes an assignment zone ID, a building ID, a berth ID, a start time, and an end time. The assignment zone ID is identification information for identifying the assignment zone.

In the example in FIG. 5, the assignment zone information whose assignment zone ID is “T1” is registered for a time zone 11:00 to 15:00 in the berth Al of the building A. Hereinafter, the assignment zone whose assignment zone ID is “d” may be referred to as an assignment zone d. In the present embodiment, the vehicle 1 to be assigned to the assignment zone T1 is selected from the vehicles X, Y, and Z.

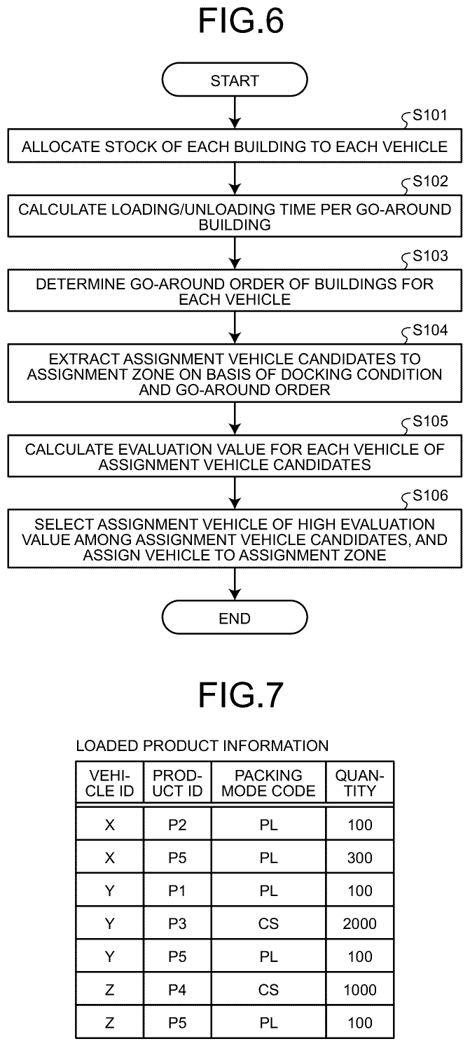

Next, the operation of each unit of the processing unit 110 will be described with reference to the flowchart in FIG. 6. FIG. 6 is a flowchart illustrating an example of the berth assignment processing according to the present embodiment. The berth assignment processing is processing of assigning the vehicle 1 to the assignment zone of the berth 5 designated on the basis of the assignment zone information.

First, the allocation unit 111 allocates the stock of each building 4 to each vehicle 1 (Step S101). For example, the allocation unit 111 counts the allocated stock of each building 4 for each vehicle 1 using the loaded product information, the warehouse capacity information, and the allocation priority master included in the input database 121, and outputs allocation information included in the intermediate database 122.

FIG. 7 is a diagram illustrating an example of a data structure and data of the loaded product information. The loaded product information indicates information on each product to be loaded on the vehicle 1 or each loaded product per vehicle 1. As illustrated in FIG. 7, the loaded product information includes a vehicle ID, a product ID, a packing mode code, and a quantity. The product ID is identification information for identifying a product. Hereinafter, a product whose product ID is “e” may be referred to as a product e. The packing mode code is identification information for identifying the packing mode. Packing mode codes PL and CS in FIG. 7 indicate that packing modes are respectively a pallet and a case.

In the example in FIG. 7, five (types of) products P1 to P5 are registered. The quantity of any (one or a plurality) of the five products is registered for the vehicles X, Y, and Z. Note that the quantity indicates the quantity to be loaded at a time of outgoing, and indicates the quantity to be unloaded at a time of incoming. In a case where, for example, the incoming/outgoing mode as illustrated in FIG. 4 is registered, the quantities of the vehicles X and Y for outgoing “O” indicate the quantities to be loaded. The quantity of the vehicle Z for incoming “I” indicates the quantity to be unloaded.

Furthermore, the quantity is registered together with the packing mode code that indicates the packing form at a time of loading/unloading work. For example, the products P2, which are scheduled to be loaded onto the vehicle X, are in 100 pallets, and the products P4, which are scheduled to be unloaded from the vehicle Z, are in 1000 cases.

FIG. 8 is a diagram illustrating an example of a data structure and data of the warehouse capacity information. The warehouse capacity information indicates information related to products stored in the building 4 for each building 4. As illustrated in FIG. 8, the warehouse capacity information includes a building ID, a product ID, a packing mode code, and a quantity.

FIG. 8 illustrates an example where the products P1 to P3 are stored in the building A, and the products P3to P5 are stored in the building B. Note that the products P3 are stored in both of the building A and the building B in a distributed manner (distributed stocks).

The quantity indicates the quantity of stock (stock quantity) of the corresponding product in the corresponding building 4. Similarly to the loaded product information in FIG. 7, the stock quantity is registered together with the packing mode code.

In Step S101 in FIG. 6, for example, the allocation unit 111 determines from which building 4 the stock corresponding to the quantity of the loaded product information is to be allocated, and subtracts from (ships) or adds to (stores) the quantity of the warehouse capacity information for checking.

For example, the products P2 of the vehicle X are stored in the building A, and 5000 as the stock quantity in the building A is larger than 100 as the quantity shipped by the vehicle X. Hence, the allocation unit 111 determines that the products P2 to be shipped are loaded at the building A. Furthermore, since, for example, the products P5 of the vehicle Z are stored in the building B, the allocation unit 111 determines that the products P5 to be stored are unloaded in the building B. According to stock allocation at the time of incoming, a stock whose quantity is zero may be registered in the warehouse capacity information to enable allocation even when the stock is zero.

The products P3 of the vehicle Y are in the distributed stocks as described above. In the case of the distributed stocks, the allocation unit 111 may refer to the allocation priority master, and execute allocation using the allocation priority of each building 4. Note that the allocation priority master, the work efficiency master, the incidental work master, and the like may be separately registered for incoming and outgoing.

FIG. 9 is a diagram illustrating an example of a data structure and data of the allocation priority master. A priority (allocation priority) determined for each of the plurality of buildings 4 is registered in the allocation priority master.

The products P3 are stored as distributed stocks in the building A and the building B, and the building A has a higher allocation priority than that of the building B. Hence, the allocation unit 111 first allocates the stock of the building A. If the stock runs out in the building A, the allocation unit 111 further allocates the stock of the building B.

In the examples in FIGS. 7 and 8, while 2000 cases of the products P3 for the vehicle Y need to be shipped, the stock of the building A is 1000 cases. Hence, the allocation unit 111 first allocates 1000 cases from the building A, and allocates the remaining 1000 cases from the building B.

Note that, although the allocation priority is commonly set for all products in the example in FIG. 9, the allocation priority may be set per product or per product group.

The allocation unit 111 outputs an allocation result as the allocation information included in the intermediate database 122.

FIG. 10 is a diagram illustrating an example of a data structure and data of the allocation information. As illustrated in FIG. 10, the allocation information includes a vehicle ID, a building ID, a packing mode code, and a quantity. The building ID is a building ID of the building 4 from which the stock is allocated to the vehicle 1 of the corresponding vehicle ID. The quantity is the quantity of a stock allocated to the allocated building ID. In this way, the allocated quantity is registered per the vehicle 1, the building 4, and the packing mode in the allocation information.

Note that the allocation information in FIG. 10 has a data structure in which, when plural products are allocated from the certain building 4, a value obtained by summing the quantities of the plural products is registered. The data structure is not limited thereto, and, when, for example, the work efficiency is calculated for each product or each product group, the quantity of each product or each product group may be registered.

The description returns to the flowchart in FIG. 6. The time calculation unit 112 calculates the loading/unloading time of each building 4 (go-around building) to which the stock is allocated (Step S102). For example, the time calculation unit 112 calculates the loading/unloading time of each vehicle 1 at the go-around building using the allocation information included in the intermediate database 122 and the information of the work efficiency master included in the input database 121, and outputs the loading/unloading time to the loading/unloading time information included in the intermediate database 122.

FIG. 11 is a diagram illustrating an example of a data structure and data of the work efficiency master. As illustrated in FIG. 11, the work efficiency master includes a building ID, a packing mode code, and work efficiency. The work efficiency is indicated by, for example, a quantity (such as pallet/h or case/h) that can be loaded or unloaded per hour. In the example in FIG. 11, the work efficiency is registered per building 4 and packing mode.

In a case where the work efficiency is indicated as illustrated in FIG. 11, the time calculation unit 112 calculates the loading/unloading time of each vehicle 1 and building 4 by, for example, dividing the quantity of the allocation information by the work efficiency. When a plurality of quantities are registered per vehicle 1 and building, the time calculation unit 112 sets a total of loading/unloading times calculated for the plurality of quantities as the loading/unloading time of each of vehicle 1 and building 4. For example, in the example in FIG. 10, two quantities (100 pallets and 1000 cases) are registered for the building A for the vehicle Y. The time calculation unit 112 calculates 2 h that is a total of 1 h (1 hour) in loading/unloading time for 100 pallets in quantity and 1 h (1 hour) in loading/unloading time for 1000 cases in quantity as the loading/unloading time for the vehicle Y and the building A.

FIG. 12 is a diagram illustrating an example of a data structure and data of the loading/unloading time information. As illustrated in FIG. 12, the loading/unloading time information includes a vehicle ID, a building ID, and a loading/unloading time.

The description returns to the flowchart in FIG. 6. The order determination unit 113 determines the go-around order of the go-around buildings for each vehicle 1 (Step S103). For example, the order determination unit 113 determines the go-around order of the buildings 4 for each vehicle 1 by using the loading/unloading time information included in the intermediate database 122 and the information of the movement time master, the vehicle state information, and the incidental work master of the input database 121, and outputs the go-around order to the go-around order information included in the intermediate database 122.

FIG. 13 is a diagram illustrating an example of a data structure and data of the movement time master. The movement time master registers a time required to move between the entrance/exit gate 3 and each building 4 or between the two buildings 4. As illustrated in FIG. 13, the movement time master includes a building ID_1, a building ID_2, and a required time. Identification information (building ID) of the building 4 or identification information (“G” in the example in FIG. 13) of the entrance/exit gate is set to the building ID_1 and the building ID_2.

FIG. 14 is a diagram illustrating an example of a data structure and data of the vehicle state information. The vehicle state information is information that indicates the state of the vehicle 1. As illustrated in FIG. 14, the vehicle state information includes a vehicle ID, a current position, a start time, and a status code.

The current position indicates a position at which the vehicle 1 identified on the basis of the vehicle ID exists. The current position may be designated in units of the buildings 4 or the entrance/exit gates. FIG. 14 illustrates an example where the current position is designated on the basis of the identification information of the building 4 or the entrance/exit gate.

The start time indicates a time (the earliest time at which berth assignment can be executed) at which the berth assignment of each vehicle 1 is started. In a case of, for example, the vehicle 1 that is waiting, the start time can be a time at which a processing result of the information processing apparatus 100 is reflected. On the other hand, in a case of the vehicle 1 before arrival at the warehouse or the vehicle 1 that is executing some work, a more future time is set to the start time.

The status code indicates a state of each vehicle 1. The status code (state) includes, for example, before arrival (NA), during loading/unloading (LD), during movement (MV), during waiting (WT), and after departure (DP). FIG. 14 is an example of the vehicle state

information at a point of time of 10:00. Since the vehicle X and the vehicle Y are waiting near the building A and the building B, respectively, and can immediately become berth assignment targets, the start time is set to 10:00. Since the vehicle Z is before arrival and is scheduled to enter the gate at 12:00, the start time is set to 12:00. That is, the vehicle Z becomes the berth assignment target at or after 12:00.

FIG. 15 is a diagram illustrating an example of a data structure and data of the incidental work master. The incidental work indicates work required before and after loading/unloading work. The incidental work is, for example, communication and related procedures at a time of gate entry and exit. The incidental work includes pre-incidental work performed before the loading/unloading work starts, and post-incidental work performed after the loading/unloading work ends. Note that, since it is considered that the incidental work does not occupy the berth 5, it is assumed that the incidental work is not included in the time zone of the assignment zone.

As illustrated in FIG. 15, the incidental work master includes a building ID, a berth ID, pre-incidental work, post-incidental work, and a work interval. The work interval is a minimum value of a time between consecutive loading/unloading works at the same berth 5. In the example in FIG. 15, the incidental work is set in units of the buildings 4 and the berths 5. The units of the incidental work are not limited thereto, and may be set in, for example, units of the vehicles 1 (drivers).

FIG. 16 is a diagram illustrating an example of a data structure and data of go-around order information. As illustrated in FIG. 16, the go-around order information includes a vehicle ID, a building ID, a go-around order, a loading/unloading start time, and a loading/unloading end time. The go-around order indicates the determined go-around order. The loading/unloading start time and the loading/unloading end time indicate a start time and an end time of the loading/unloading work, respectively.

The order determination unit 113 determines the go-around order and times (scheduled event times) of one or more scheduled events by a method described below. The order determination unit 113 registers the start time and the end time of the loading/unloading work among the scheduled event times as the loading/unloading start time and the loading/unloading end time.

The go-around order can be determined by, for example, the following procedure.
(M1) The go-around order is determined on the basis of an ascending order of loading/unloading times, a descending order of the loading/unloading times, or the priority (priority for determining the order) of each of the plurality of buildings 4.
(M2) The go-around order is determined so as to smooth the degrees of congestion of the respective buildings 4 calculated using the loading/unloading time.
(M3) The go-around order is determined at random.

The degree of congestion indicates the degree of congestion (concentration) of the vehicle 1 assigned to the one building 4. Hereinafter, an example of (M2) will be described. First, the order determination unit 113 temporarily determines the go-around order for each vehicle 1 in advance by a simple method. For example, above (M1) is applicable to temporary determination. The order determination unit 113 divides the range of the scheduled gate entry time to the scheduled gate exit time in the go-around order temporarily determined for the vehicle 1 and at a ratio of the loading/unloading time per vehicle 1, and labels the go-around building in each divided time zone. The order determination unit 113 can estimate the degree of congestion of each go-around building at a certain time by counting the number of vehicles per labeled go-around building at the certain time.

The order determination unit 113 determines the go-around order so as to smooth the degrees of congestion of the respective go-around buildings calculated in this way. For example, the order determination unit 113 determines the go-around order that D the degrees of congestion by correcting the temporarily determined go-around order so as to minimize the cost function calculated from the degree of congestion.

The cost function is expressed by, for example, following equation (1). The average degree of congestion indicates an average value of the degrees of congestion of all go-around buildings at each time.

Cost function=total sum of all times of (degree of congestion−average degree of congestion)\hat{ }2 (1)

The above processing can be processing of selecting an optimum plan from a number of correction plan (correction plans of the go-around order) candidates corresponding to the “(the number of buildings!)\hat{ } the number of vehicles”. Therefore, when the number of buildings and the number of vehicles increase, the calculation amount may become excessive. In consideration of such a case, the order determination unit 113 may determine the go-around order that smooths the degree of congestion by applying an optimization method applicable to a large-scale combinatorial optimization problem. The optimization method is, for example, the following method.
Genetic Algorithm (GA) and metaheuristic solution such as Simulated Annealing (SA)
Fast heuristic solutions such as a greedy algorithm and a local improvement method

The degree of congestion, a cost function, and the optimization method are not limited to the above, and any other degrees of congestion, cost functions, and optimization methods may be used.

The order determination unit 113 may determine the go-around order so as to smooth the degrees of congestion using the allocation priority for each of the plurality of buildings 4 as a parameter. Parameterizing allocation priorities can be interpreted as corresponding to parameterizing allocations of distributed stocks.

When, for example, the products P3 are the distributed stocks as illustrated in FIG. 8, and the allocation priority of the building A is higher as illustrated in FIG. 9, the loading/unloading times of the vehicle Y at the building A and at the building B are each two hours (FIG. 12). If the allocation priority of the building B is higher, all the products P3 (the quantity for the vehicles Y is 2000) can be allocated from the building B (the quantity of the products P3 is 40000). Therefore, the loading/unloading times of the vehicle Y at the building A and the building B are respectively one hour and three hours. The loading/unloading times are changed and, as a result, the degree of congestion can be also changed. Consequently, by optimizing the degree of congestion by parameterizing the allocation priority of each building 4, a go-around order of a smaller degree of congestion is obtainable.

Next, a method for calculating the scheduled event time of each vehicle 1 will be described. The scheduled event time indicates a start time and an end time of each scheduled event in a case where a plurality of scheduled events progress according to a required time (without considering waiting for a berth due to congestion of vehicles).

Examples of the scheduled event include following events. Note that the following events proceed in a described order.
(I1) Gate entry
(I2) Movement
(I3) Pre-incidental work
(I4) Loading/unloading work
(I5) Post-incidental work
(I6) Movement
(I7) Repetition of 13 to 16 for the number of going-around buildings
(I8) Gate exit

The time of gate entry can be acquired from the registered vehicle information (scheduled gate entry time), a required time of movement can be acquired from the movement time master, required times of the pre-incidental work and the post-incidental work can be acquired from the incidental work master, and a required time of the loading/unloading work can be acquired from the loading/unloading time information.

Note that the vehicle 1 whose status code is other than before arrival (NA) or after departure (DP) in the vehicle state information is in the middle of any event between (I1) gate entry and (I8) gate exit. Hence, the order determination unit 113 calculates the scheduled event time by setting the start time of the vehicle state information as a starting point, and causing an event in the middle to progress within a required time. When the status code is before arrival (NA) in the vehicle state information, the order determination unit 113 calculates the scheduled event time by, for example, setting the event time of gate entry as the scheduled gate entry time and causing a subsequent event to progress within a required time. When the status code is before arrival (DP) in the vehicle state information, the order determination unit 113 does not need to calculate the scheduled event time. Note that, when the status code is other than before arrival (NA), an actual time may be acquired from the vehicle management apparatus 200 for an event that has already occurred. The order determination unit 113 stores the start time and the end time of the loading/unloading work in the go-around order information on the basis of the calculated scheduled event time.

Similarly to the above, a case where the input database 121 stores the data illustrated in each figure will be described as an example. In this example, such a go-around order is obtained that the vehicle X goes in order of the building A→the building B→the entrance/exit gate G, the vehicle Y goes in order of the building B→the building A→the entrance/exit gate G, and the vehicle Z goes in order of the entrance/exit gate G→the building B→the entrance/exit gate G. The scheduled event time of each vehicle 1 is calculated as follows. For example, “@A” indicates that work is executed in the building A, and “@B→G” indicates movement from the building B to the entrance/exit gate G.
Vehicle X
Pre-incidental work @A: 10:00 to 10:10
Loading/unloading work @A: 10:10 to 11:10
Post-incidental work @A: 11:10 to 11:20
Movement @A→B: 11:20 to 11:50
Pre-incidental work @B: 11:50 to 11:55
Loading/unloading work @B: 11:55 to 14:55
Post-incidental work @B: 14:55 to 15:00
Movement @B→G: 15:00 to 15:20
Vehicle Y
Pre-incidental work @B: 10:00 to 10:05
Loading/unloading work @B: 10:05 to 12:05
Post-incidental work @B: 12:05 to 12:10
Movement @B→A: 12:10 to 12:40
Pre-incidental work @A: 12:40 to 12:50
Loading/unloading work @A: 12:50 to 14:50
Post-incidental work @A: 14:50 to 15:00
Movement @A→G: 15:00 to 15:20
Vehicle Z
Movement @G→B: 12:00 to 12:20
Pre-incidental work @B: 12:20 to 12:25
Loading/unloading work @B: 12:25 to 14:25
Post-incidental work @B: 14:25 to 14:30
Movement @B→G: 14:30 to 14:50

The order determination unit 113 registers the start time and the end time of the loading/unloading work (the gate entry time or the gate exit time in the case of the entrance/exit gate G) among the scheduled event times in the go-around order information.

The description returns to the flowchart in FIG. 6. The candidate extraction unit 114 extracts assignment vehicle candidates for the assignment zone by using information such as the docking condition and the go-around order (Step S104). For example, the candidate extraction unit 114 extracts candidates of the vehicles 1 that can be assigned to the assignment zone using the go-around order information included in the intermediate database 122 and the registered vehicle information, the assignment zone information, and the docking condition (the vehicle size condition, the warehousing in/out condition, and the route condition) included in the input database 121, and outputs assignment vehicle candidate evaluation information included in the intermediate database 122.

FIG. 17 is a diagram illustrating an example of a data structure and data of the vehicle size condition. As illustrated in FIG. 17, the vehicle size condition includes a building ID, a berth ID, a size lower limit, and a size upper limit. The size lower limit and the size upper limit indicate the lower limit and the upper limit of the size of the vehicle 1 that can be docked at the berth 5 identified on the basis of the corresponding building ID and berth ID. Therefore, the vehicle 1 whose vehicle size set in the registered vehicle information is not within the range of the size lower limit to the size upper limit cannot be assigned to the corresponding berth 5.

FIG. 18 is a diagram illustrating an example of a data structure and data of the warehousing in/out condition. The warehousing in/out condition is a condition of each berth 5 indicating that only the vehicle 1 for incoming or outgoing is accepted in a specific time zone. As illustrated in FIG. 18, the warehousing in/out condition includes a building ID, a berth ID, a start time, an end time, and an incoming/outgoing mode. The start time and the end time indicate a start time and an end time of a time zone during which only the vehicle 1 for loading/unloading work (outgoing or incoming) designated in the incoming/outgoing mode is accepted. At the berth 5 and the time zone to which the warehousing in/out condition is not registered, the vehicles 1 for any one of incoming and outgoing can be also accepted.

FIG. 19 is a diagram illustrating an example of a data structure and data of the route condition. The route condition is a condition of each berth 5 that indicates that only the vehicle 1 belonging to a specific route is accepted in a specific time zone. As illustrated in FIG. 19, the route condition includes a building ID, a berth ID, a start time, an end time, and a route code. The start time and the end time indicate a start time and an end time of a time zone in which only the vehicle 1 belonging to a route designated by the route code is accepted. At the berth 5 and the time zone to which the route condition is not registered, all the vehicles 1 can be accepted.

The candidate extraction unit 114 extracts candidates from the vehicles 1 that satisfy the docking condition (the vehicle size condition, the warehousing in/out condition, and the route condition). Note that the docking condition may be part of the vehicle size condition, the warehousing in/out condition, and the route condition.

In the example where the input database 121 stores the data illustrated in each figure, the vehicles X, Y, and Z satisfy the docking condition as for the assignment zone T1. Hence, the candidate extraction unit 114 refers to the scheduled event time calculated as described above, and extracts a vehicle that can be assigned to the assignment zone T1 from the vehicles X, Y, and Z.

Since the assignment zone T1 is 11:00 to 15:00 of the berth A1, the assignment zone T1 corresponds to the loading/unloading work of the vehicle X @A: 10:10 to 11:10 and the loading/unloading work of the vehicle Y @A: 12:50 to 14:50 among the above scheduled event times. The vehicle X can be assigned to the assignment zone T1 by shifting the scheduled event time by 50 minutes behind and correcting the scheduled event time to 11:00 to 12:00. The vehicle Y can be directly assigned to the assignment zone T1 by using the calculated scheduled event time (12:50 to 14:50) as is. Hence, the candidate extraction unit 114 extracts both of the vehicle X and the vehicle Y as assignment vehicle candidates, and registers the assignment vehicle candidates in the assignment vehicle candidate evaluation information.

FIG. 20 is a diagram illustrating an example of a data structure and data of the assignment vehicle candidate evaluation information. As illustrated in FIG. 20, the assignment vehicle candidate evaluation information includes an assignment zone ID, a vehicle ID, a start time, an end time, and an evaluation value. The start time and the end time are a start time and an end time of the scheduled event time (the corrected scheduled event time in a case where the scheduled event time is corrected) to be assigned. Note that the evaluation value is not set at a time at which the candidates are extracted.

The description returns to the flowchart in FIG. 6. The evaluation value calculation unit 115 calculates an evaluation value for each vehicle 1 of the assignment vehicle candidates (Step S105). For example, the evaluation value calculation unit 115 calculates the evaluation value related to the assignment of each assignment vehicle candidate to the assignment zone using the assignment vehicle candidate evaluation information included in the intermediate database 122 and the information such as the registered vehicle information included in the input database 121, and updates the evaluation value of the assignment vehicle candidate evaluation information included in the intermediate database 122.

In the example in FIG. 20, a case where evaluation values whose values become larger in a descending order of a gate exit delay time are used will be described. Since the vehicle X is assigned to the assignment zone T1 by being shifted 50 minutes behind, the end time (gate exit time) of the scheduled event for moving to the entrance/exit gate is 16:10 (15: 20+50 minutes). Hence, the gate exit delay time that is a difference between 15:00 of the scheduled gate exit time of the vehicle X (the registered vehicle information in FIGS. 4) and 16:10 of the gate exit time is 70 minutes. Since the vehicle Y is assigned to the assignment zone T1 using the scheduled event time as is, the gate exit time is 15:20.Hence, the gate exit delay time that is a difference between 15:30 of the scheduled gate exit time of the vehicle Y and 15:20 of the gate exit time is −10 minutes (10 minutes ahead).

The evaluation value calculation unit 115 updates the assignment vehicle candidate evaluation information using, for example, the gate exit delay time as the evaluation value. FIG. 20 illustrates an example of the updated assignment vehicle candidate evaluation information. Note that the evaluation value may be calculated in a complex manner by combining a plurality of methods (e.g., above E1 to E3).

The description returns to the flowchart in FIG. 6. The assignment unit 116 selects an assignment vehicle having a high evaluation value from the assignment vehicle candidates, and assigns the assignment vehicle to the assignment zone (Step S106). For example, the assignment unit 116 selects the vehicle 1 to be assigned to the assignment zone using the assignment vehicle candidate evaluation information included in the intermediate database 122, and outputs the assignment vehicle information included in the output database 123.

FIG. 21 is a diagram illustrating an example of a data structure and data of the assignment vehicle information. As illustrated in FIG. 21, the assignment vehicle information includes an assignment zone ID, a building ID, a berth ID, a start time, an end time, and a vehicle ID. The vehicle ID is a vehicle ID of the vehicle 1 assigned to the assignment zone identified on the basis of the assignment zone ID.

In the example in FIG. 21, the assignment unit 116 selects the vehicle X having a large evaluation value from the vehicle X and the vehicle Y that are assignment vehicle candidates. Note that the assignment unit 116 may select the plurality of vehicles 1 in consideration of a possibility that the selected vehicle 1 cannot be assigned for some reason. In this case, the assignment unit 116 may select the plurality of vehicles 1 by, for example, assigning ranks in order from a larger evaluation value.

As described above, the information processing apparatus according to the first embodiment can more appropriately assign the vehicle 1 to an area (berth) in which the loading/unloading work is performed using, for example, the above functions F1 to F6.

### Second Embodiment

As in a use case U2 described above, an information processing apparatus according to the second embodiment creates a berth assignment plan of all vehicles in a certain period.

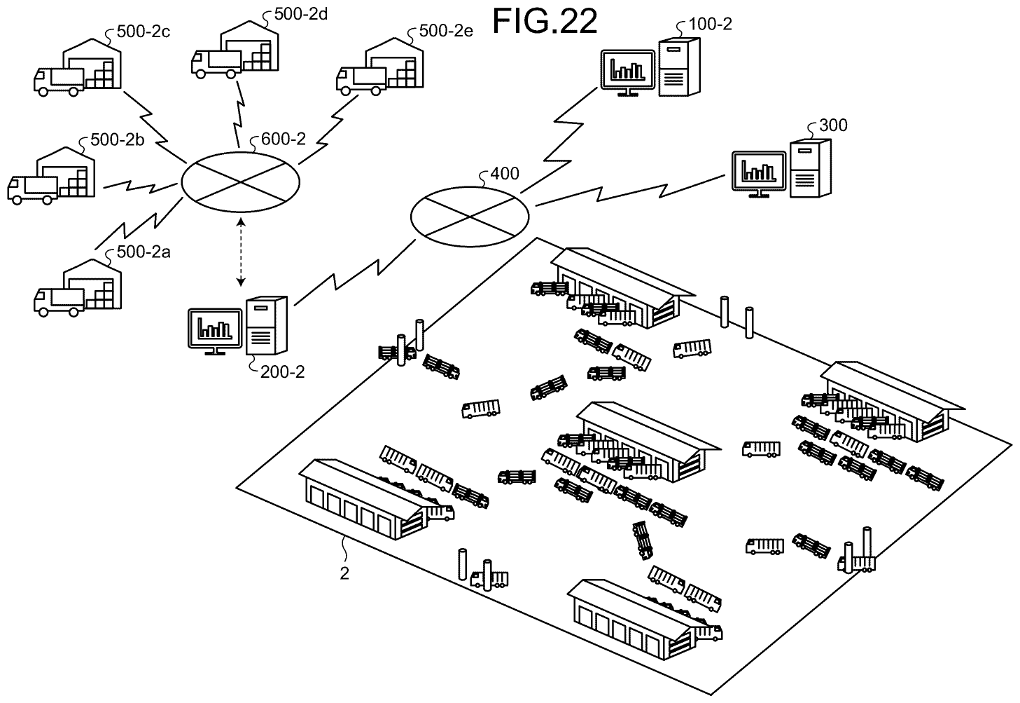

FIG. 22 is a schematic diagram of an information processing system including an information processing apparatus 100-2 according to the second embodiment. As illustrated in FIG. 22, the information processing system according to the present embodiment includes a plurality of vehicles 1, a warehouse 2, the information processing apparatus 100-2, a vehicle management apparatus 200-2, a warehouse management apparatus 300, a network 400, a plurality of transportation companies 500-2a to 500-2e, and a network 600-2. The same components as those of the first embodiment will be assigned the same reference numerals, and the description thereof will be omitted.

The network 600-2 is a network for performing data communication between the vehicle management apparatus 200-2 and the plurality of transportation companies 500-2a to 500-2e. The network 600-2 may be any form of a network, and is, for example, a Local Area Network (LAN) or the Internet. The network 600-2 may be integrated with the network 400.

The transportation companies 500-2a to 500-2e correspond to companies that use the warehouse 2. The transportation companies 500-2a to 500-2e may be simply referred to as a transportation company 500-2 in a case where the transportation companies 500-2a to 500-2e do not need to be distinguished.

The vehicle management apparatus 200-2 further has a function of accepting a car dispatch reservation request from the transportation company 500-2 via the network 600-2, and transmitting a car dispatch reservation result to the transportation company 500-2. For example, car dispatch reservation means assigning a berth 5 of the warehouse 2 to the vehicle 1 managed by each transportation company 500-2, and reserving use of the assigned berth 5. The information processing system according to the present embodiment can be applied to, for example, a service for reserving car dispatch for a next day on the basis of information on a use wish of the warehouse 2 transmitted from the transportation company 500-2 until a previous day.

The information processing apparatus 100-2 assigns the vehicle 1 of each transportation company 500-2 to the berth 5 on the basis of the information from the vehicle management apparatus 200-2 and the warehouse management apparatus 300. For example, in a specific period (e.g., next day) in the future, the information processing apparatus 100-2 performs processing of assigning the loading/unloading work of each vehicle 1 to an available time zone of each berth 5, and displays a processing result for a user or transmits the processing result to the transportation company 500-2 via the vehicle management apparatus 200-2.

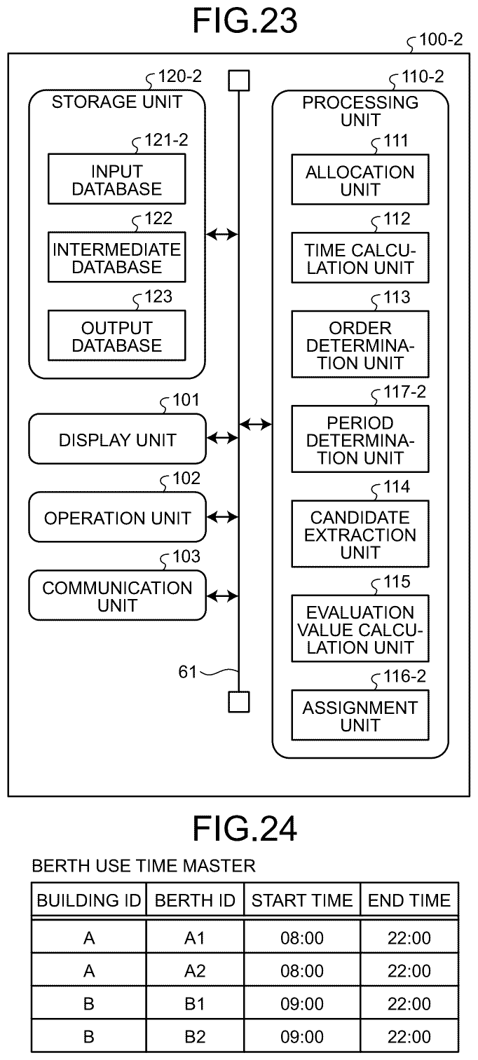

FIG. 23 is a block diagram illustrating an example of a configuration of the information processing apparatus 100-2 according to the second embodiment. As illustrated in FIG. 23, the information processing apparatus 100-2 includes a processing unit 110-2, a storage unit 120-2, a display unit 101, an operation unit 102, a communication unit 103, and a bus 61.

In the second embodiment, the functions of the processing unit 110-2 and the storage unit 120-2 are different from those of the first embodiment. Other configurations and functions are similar to those in FIG. 2 that is a block diagram of the information processing apparatus 100 according to the first embodiment, and are assigned the same reference numerals, and description thereof here is omitted.

The storage unit 120-2 stores an input database 121-2, an intermediate database 122, and an output database 123. The input database 121-2 according to the second embodiment differs from the input database 121 according to the first embodiment in that the input database 121-2 further includes a berth use time master and an unavailable berth condition.

The processing unit 110-2 differs from the processing unit 110 according to the first embodiment in terms of a function of an assignment unit 116-2 and addition of a period determination unit 117-2.

The period determination unit 117-2 determines one or more assignment zones on the basis of a time at which each berth 5 is available. The period determination unit 117-2 corresponds to a function of aggregating assignment zones (available time zones) of all the berths 5 in each building 4. For example, the period determination unit 117-2 refers to the berth use time master, and specifies a time zone in which each berth 5 becomes available, that is, an assignment zone.

FIG. 24 is a diagram illustrating an example of a data structure and data of the berth use time master. The berth use time master is data for managing an available time zone of the berth 5 in each building 4. As illustrated in FIG. 24, the berth use time master includes a building ID, a berth ID, a start time, and an end time.

The period determination unit 117-2 can grasp a time zone (a time zone from a start time to an end time) in which each berth 5 is available in each building 4 (a building A and a building B) by referring to the berth use time master. For example, a berth Al is available in a time zone of 8:00 to 22:00.

The period determination unit 117-2 further refers to the unavailable berth condition that indicates that the berth 5 is unavailable, and specifies a time zone in which each berth 5 is unavailable. The period determination unit 117-2 determines a time zone of the berth 5 that is available at a specific point of time, that is, an assignment zone by cross-checking information of the berth use time master and the unavailable berth condition.

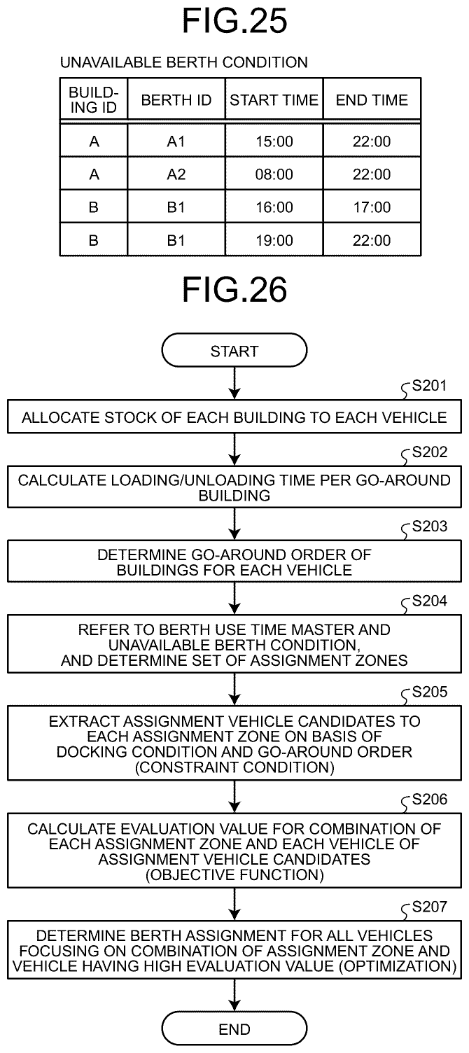

FIG. 25 is a diagram illustrating an example of a data structure and data of the unavailable berth condition. The unavailable berth condition is a condition that the berth 5 is unavailable such as a condition indicating a time zone in which the berth 5 is unavailable. The time zone in which the berth 5 is unavailable is, for example, a time zone in which maintenance or the like is executed. As illustrated in FIG. 25, the unavailable berth condition includes a building ID, a berth ID, a start time, and an end time.

The period determination unit 117-2 can grasp a time zone (a time zone from the start time to the end time) in which each berth 5 in each building 4 (the building A and the building B) is unavailable by referring to the unavailable berth condition. The unavailable berth condition functions in cooperation with the berth use time master, and is used to clearly define an effective time zone to which the vehicle 1 needs to be allocated.

Although the berth A1 is available at 8:00 to 22:00 according to, for example, the berth use time master (FIG. 24), the berth A1 is unavailable at 15:00 to 22:00 according to the unavailable berth condition (FIG. 25). The period determination unit 117-2 determines (extracts) an assignment zone of 8:00 to 15:00 at maximum for the berth Al on the basis of these pieces of information.

Note that the berth 5 and the time zone that are not registered in the unavailable berth condition among time zones registered in the berth use time master mean that the vehicle 1 can be assigned. That is, the berth 5 is considered to be available in the time zone that is not registered in the unavailable berth condition, and can be used to assign the vehicle 1.

The period determination unit 117-2 performs the above analysis on all the berths 5 of all the buildings 4, and determines (extracts) all available assignment zones (a set of the assignment zones).

The assignment unit 116-2 assigns one or more vehicles to each assignment zone determined by the period determination unit 117-2. The assignment unit 116-2 corresponds to a function of optimally matching one or more available assignment zones and the one or more vehicles 1.

To more effectively use the berth 5, it is desirable to assign the appropriate vehicle 1 to an appropriate time zone from a large number of the possible vehicles 1. The assignment unit 116-2 has a function of managing a process for this assignment. That is, the assignment unit 116-2 derives the most reasonable combination from combinations of the multiple vehicles 1 and limited assignment zones. To derive the most reasonable combination, the assignment unit 116-2 performs not only berth assignment on the basis of calculation of an evaluation value, but also check on possibility of assignment and matching with the vehicle 1, and executes an optimization method for maximizing efficiency and an effect as a whole.

Next, an operation of each unit of the processing unit 110-2 will be described with reference to a flowchart in FIG. 26. FIG. 26 is the flowchart illustrating an example of berth assignment processing according to the present embodiment. The berth assignment processing according to the present embodiment is processing of determining an assignment zone for the plurality of berths 5 and assigning the vehicle 1 to the determined assignment zone.

Since Steps S201 to S203 are processing similar to Steps S101 to S103 in the information processing apparatus 100 according to the first embodiment, description thereof will be omitted.

In the present embodiment, the period determination unit 117-2 refers to the berth use time master and the unavailable berth condition, specifies a time zone in which each berth 5 is available, and determines (extracts) a set of the specified time zones as a set of assignment zones (Step S204).

Next, the candidate extraction unit 114 extracts assignment vehicle candidates for each assignment zone included in the set of assignment zones using information such as a docking condition and a go-around order (Step S205). This processing is processing required to satisfy a constraint condition. In this processing, combinations of all the vehicles 1 and all the assignment zones included in the set of assignment zones are evaluated as a possibility.

Next, the assignment unit 116-2 calculates an evaluation value for each combination of each assignment zone and each vehicle of the assignment vehicle candidates (Step S206). As a method (objective function) for calculating the evaluation value, the same method as that of the first embodiment is applicable. The assignment unit 116-2 determines final berth assignment of all the vehicles 1 focusing on a combination of the highest objective function (evaluation value) (Step S207).

The assignment unit 116-2 may use the optimization method to prevent an explosive increase in combinations. Depending on an order to consider the constraint condition and the objective function, the berth assignment result may greatly vary. Hence, the assignment unit 116-2 may determine the berth assignment by applying the optimization method applicable to a large-scale combinatorial optimization problem. The optimization method is, for example, the following method.
Genetic Algorithm (GA) and metaheuristic solution such as Simulated Annealing (SA)
Fast heuristic solutions such as a greedy algorithm and a local improvement method

Consequently, the information processing apparatus 100-2 can derive optimum berth assignment for each vehicle 1, and maximize the efficiency and the effect of the entire system.

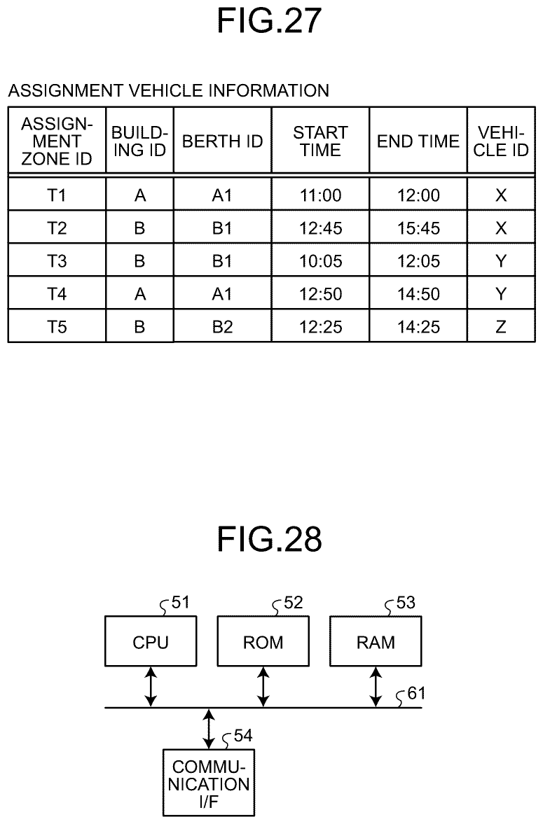

FIG. 27 is a diagram illustrating an example of the assignment vehicle information included in the output database 123 according to the second embodiment. The assignment vehicle information according to the second embodiment has the same data structure as that of the assignment vehicle information according to the first embodiment, yet differs in outputting a berth assignment result for a plurality of assignment zones. That is, while the assignment vehicle information (FIG. 21) according to the first embodiment is an assignment result only for the assignment zone T1, the assignment vehicle information in FIG. 27 includes berth assignment results for five assignment zones T1 to T5 corresponding to any one of the four berths 5 of the two buildings 4.

For example, loading/unloading work of a vehicle X at 11:00 to 12:00 is assigned to the berth Al of the building A, and then loading/unloading work of a vehicle Y at 12:50 to 14:50 is assigned thereto.

The processing unit 110-2 may output (display), to the display unit 101, a display screen (such as a Gantt chart of a berth viewpoint) that displays an assigned vehicle and an assignment zone of each berth 5. Consequently, for example, the user can check a use schedule of the berth 5.

On the other hand, it is possible to grasp from the assignment vehicle information in FIG. 27 that, for example, the vehicle X performs loading/unloading work at the building A at 11:00 to 12:00, and then performs loading/unloading work at the building B at 12:45 to 15:45. Hence, the processing unit 110-2 may output (display), to the display unit 101, a display screen (such as a Gantt chart of a vehicle viewpoint) that displays an assigned berth and an assignment zone of each vehicle 1. Consequently, for example, the user can check a scheduled event of the vehicle 1.

As described above, the information processing apparatus according to the second embodiment can determine one or more assignment zones for one or more berths, and more appropriately assign a vehicle to the determined assignment zone.

As described above, according to the first and second embodiments, it is possible to more appropriately assign the vehicle to an area in which loading/unloading work is performed.

Next, a hardware configuration of each apparatus (the information processing apparatus, the vehicle management apparatus, and the warehouse management apparatus) according to the first or second embodiment will be described with reference to FIG. 28. FIG. 28 is an explanatory view illustrating the hardware configuration example of the apparatus according to the first or second embodiment.

The apparatus according to the first or second embodiment includes a control apparatus such as a Central Processing Unit (CPU) 51, storage apparatuses such as a Read Only Memory (ROM) 52 and a Random Access Memory (RAM) 53, a communication I/F 54 that is connected to a network and performs communication, and the bus 61 that connects the respective units. In the case of, for example, the information processing apparatus 100, a CPU15 corresponds to the processing unit 110, the storage apparatus corresponds to a storage unit 120, and the communication I/F 54 corresponds to the communication unit 103.

Programs to be executed by the apparatus according to the first or second embodiment are incorporated in advance in the ROM52 or the like and provided.

The programs that are executed by the apparatus according to the first or second embodiment may be recorded as a file in an installable format or an executable format in a computer-readable recording medium such as a Compact Disk Read Only Memory (CD-ROM), a Flexible Disk (FD), a Compact Disk Recordable (CD-R), or a Digital Versatile Disk (DVD), and provided as a computer program product.

Furthermore, the programs that are executed by the apparatus according to the first or second embodiment may be stored on a computer connected to a network such as the Internet, downloaded via the network, and provided. Furthermore, the programs that are executed by the apparatus according to the first or second embodiment may be provided or distributed via a network such as the Internet.

The programs that are executed by the apparatus according to the first or second embodiment can cause the computer to function as each unit of the above-described apparatus. In this computer, the CPU51 can read the programs from the computer-readable storage medium onto a main storage apparatus, and execute the programs.

Configuration examples according to the embodiments will be described below.

Example 1. According to an embodiment, an information processing apparatus includes one or more hardware processors. The processors are configured to determine an order on a basis of a loading/unloading time for each of a plurality of vehicles, where the order is an order of going around a plurality of buildings each of which includes one or more loading/unloading working areas, and the loading/unloading time is calculated on a basis of an allocated stock among stocks of goods stored in the plurality of buildings. Furthermore, the processors are configured to assign one or more vehicles selected from the plurality of vehicles on a basis of the order to each of one or more target periods during which loading/unloading work is performed in each of the one or more loading/unloading working areas.

Example 2. In information processing apparatus according to example 1, the one or more hardware processors allocate to each of the plurality of vehicles a stock of goods stored in the plurality of the buildings. The one or more hardware processors calculate the loading/unloading time at the plurality of buildings on a basis of the allocated stock and predetermined efficiency of the loading/unloading work. The one or more hardware processors determine the order for each of the plurality of the vehicles on the basis of the loading/unloading time, where the order is the order of going around the plurality of buildings for the loading/unloading work of the stock allocated to the vehicle. The one or more hardware processors extract one or more candidates of the vehicle assigned to the one or more of target periods, from the plurality of vehicles on a basis of the order. The one or more hardware processors calculate an evaluation value for assignment to the target periods for each of the one or more candidates. The one or more hardware processors assign one or more vehicles to each of the one or more target periods, where the one or more vehicles are selected from the one or more candidates on a basis of the evaluation value.

Example 3. In information processing apparatus according to example 2, the one or more hardware processors calculate the loading/unloading time on a basis of the allocated stock and the efficiency in accordance with a storage state of the allocated stock.

Example 4. In information processing apparatus according to example 1 or 2, in a case where the goods of a same type are stored in the plurality of the buildings in a distributed manner, the one or more hardware processors determine the building to which the stock is allocated and a quantity of the allocated stock on a basis of a priority determined for each of the plurality of buildings.

Example 5. In information processing apparatus according to any one of examples 1 to 3, the one or more hardware processors determine the order on a basis of an ascending order of the loading/unloading time, a descending order of the loading/unloading time, or a priority determined for each of the plurality of buildings.

Example 6. In information processing apparatus according to any one of examples 1 to 4, the one or more hardware processors determine the order so as to smooth a degree of congestion of each of the plurality of buildings calculated using the loading/unloading time.

Example 7. In information processing apparatus according to example 6, the one or more hardware processors determine the order so as to smooth the degree of congestion using, as a parameter, a priority for each of the plurality of buildings.

Example 8. In information processing apparatus according to example 2, the one or more hardware processors extract the candidates from the plurality of vehicles on a basis of a docking condition determined per loading/unloading working area and the order, where the docking condition includes at least one of a condition of a size of the vehicles, a warehousing in/out condition indicating which one of incoming and outgoing is performed, and a condition indicating the vehicle for which the loading/unloading work is permitted.

Example 9. In information processing apparatus according to example 2, the one or more hardware processors calculate the evaluation value on a basis of at least one of a date and time at which the vehicle enters an area in which the plurality of the buildings are located, and a date and time at which the vehicle exits the area in which the plurality of the buildings are located.

Example 10. In information processing apparatus according to example 2, the one or more hardware processors calculate the evaluation value on a basis of a difference between a date and time at which the vehicle exits an area in which the plurality of buildings are located, and a date and time at which the vehicle is scheduled to exit the area in which the plurality of buildings are located.

Example 11. In information processing apparatus according to any one of examples 1 to 10, the one or more hardware processors determine the one or more target periods on a basis of a time during which each of the one or more loading/unloading working areas is available, and assign one or more vehicles to each of the determined one or more target periods.

Example 12. In information processing apparatus according to any one of examples 1 to 11, the one or more hardware processors as a processing unit include an order determination unit that determines the order, and an assignment unit that assigns one or more of the vehicles to each of the one or more target periods.

Example 13. According to an embodiment, an information processing method is executed by a computer of an information processing apparatus. The information processing method includes determining an order on a basis of a loading/unloading time for each of a plurality of vehicles, where the order is an order of going around a plurality of buildings each of which includes one or more loading/unloading working areas, and the loading/unloading time is calculated on a basis of an allocated stock among stocks of goods stored in the plurality of buildings. Furthermore, the information processing method includes assigning one or more vehicles selected from the plurality of vehicles on a basis of the order to each of one or more target periods during which loading/unloading work is performed in each of the one or more loading/unloading working areas.

Example 14. According to an embodiment, a computer program product has a non-transitory computer readable medium including programmed instructions stored thereon. When executed by a computer, the instructions cause the computer to execute determining an order on a basis of a loading/unloading time for each of a plurality of vehicles, where the order is an order of going around a plurality of buildings each of which includes one or more loading/unloading working areas, and the loading/unloading time is calculated on a basis of an allocated stock among stocks of goods stored in the plurality of buildings. Furthermore, the instructions cause the computer to execute assigning one or more vehicles selected from the plurality of vehicles on a basis of the order to each of one or more target periods during which loading/unloading work is performed in each of the one or more loading/unloading working areas.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising
one or more hardware processors configured to:
determine an order on a basis of a loading/unloading time for each of a plurality of vehicles, the order being an order of going around a plurality of buildings each including one or more loading/unloading working areas, and the loading/unloading time being calculated on a basis of an allocated stock among stocks of goods stored in the plurality of buildings, and
assign one or more vehicles selected from the plurality of vehicles on a basis of the order to each of one or more target periods during which loading/unloading work is performed in each of the one or more loading/unloading working areas.

2. The information processing apparatus according to claim 1, wherein
the one or more hardware processors
allocate to each of the plurality of vehicles a stock of goods stored in the plurality of the buildings,
calculate the loading/unloading time at the plurality of buildings on a basis of the allocated stock and predetermined efficiency of the loading/unloading work,
determine the order for each of the plurality of the vehicles on the basis of the loading/unloading time, the order being the order of going around the plurality of buildings for the loading/unloading work of the stock allocated to the vehicle,
extract one or more candidates of the vehicle assigned to the one or more of target periods, from the plurality of vehicles on a basis of the order,
calculate an evaluation value for assignment to the target periods for each of the one or more candidates, and
assign one or more vehicles to each of the one or more target periods, the one or more vehicles being selected from the one or more candidates on a basis of the evaluation value.

3. The information processing apparatus according to claim 2, wherein
the one or more hardware processors
calculate the loading/unloading time on a basis of the allocated stock and the efficiency in accordance with a storage state of the allocated stock.

4. The information processing apparatus according to claim 1, wherein,
in a case where the goods of a same type are stored in the plurality of the buildings in a distributed manner, the one or more hardware processors determine the building to which the stock is allocated and a quantity of the allocated stock on a basis of a priority determined for each of the plurality of buildings.

5. The information processing apparatus according to claim 1, wherein
the one or more hardware processors
determine the order on a basis of an ascending order of the loading/unloading time, a descending order of the loading/unloading time, or a priority determined for each of the plurality of buildings.

6. The information processing apparatus according to claim 1, wherein
the one or more hardware processors
determine the order so as to smooth a degree of congestion of each of the plurality of buildings calculated using the loading/unloading time.

7. The information processing apparatus according to claim 6, wherein
the one or more hardware processors
determine the order so as to smooth the degree of congestion using, as a parameter, a priority for each of the plurality of buildings.

8. The information processing apparatus according to claim 2, wherein
the one or more hardware processors
extract the candidates from the plurality of vehicles on a basis of a docking condition determined per loading/unloading working area and the order, the docking condition including at least one of a condition of a size of the vehicles, a warehousing in/out condition indicating which one of incoming and outgoing is performed, and a condition indicating the vehicle for which the loading/unloading work is permitted.

9. The information processing apparatus according to claim 2, wherein
the one or more hardware processors
calculate the evaluation value on a basis of at least one of a date and time at which the vehicle enters an area in which the plurality of the buildings are located, and a date and time at which the vehicle exits the area in which the plurality of the buildings are located.

10. The information processing apparatus according to claim 2, wherein
the one or more hardware processors
calculate the evaluation value on a basis of a difference between a date and time at which the vehicle exits an area in which the plurality of buildings are located, and a date and time at which the vehicle is scheduled to exit the area in which the plurality of buildings are located.

11. The information processing apparatus according to claim 1, wherein
the one or more hardware processors
determine the one or more target periods on a basis of a time during which each of the one or more loading/unloading working areas is available, and
assign one or more vehicles to each of the determined one or more target periods.

12. The information processing apparatus according to claim 1, wherein
the one or more hardware processors as a processing unit include
an order determination unit that determines the order, and
an assignment unit that assigns one or more of the vehicles to each of the one or more target periods.

13. An information processing method executed by a computer of an information processing apparatus, the information processing method comprising:
determining an order on a basis of a loading/unloading time for each of a plurality of vehicles, the order being an order of going around a plurality of buildings each including one or more loading/unloading working areas, and the loading/unloading time being calculated on a basis of an allocated stock among stocks of goods stored in the plurality of buildings; and
assigning one or more vehicles selected from the plurality of vehicles on a basis of the order to each of one or more target periods during which loading/unloading work is performed in each of the one or more loading/unloading working areas.

14. A computer program product having a non-transitory computer readable medium including programmed instructions stored thereon, wherein the instructions, when executed by a computer, cause the computer to execute:
determining an order on a basis of a loading/unloading time for each of a plurality of vehicles, the order being an order of going around a plurality of buildings each including one or more loading/unloading working areas, and the loading/unloading time being calculated on a basis of an allocated stock among stocks of goods stored in the plurality of buildings; and
assigning one or more vehicles selected from the plurality of vehicles on a basis of the order to each of one or more target periods during which loading/unloading work is performed in each of the one or more loading/unloading working areas.
